(19) United States
(12) Patent Application Publication
(10) Pub. No.: US 2013/0207465 A1
(43) Pub. Date: Aug. 15, 2013

(54) APPARATUS AND METHOD FOR DIRECTLY POWER NON-MOBILE COMPUTERS BY SOLAR PV ARRAY WITHOUT DC-AC AND AC-DC CONVERSIONS

(71) Applicant: Jack J. Sun, Palo Alto, CA (US)

(72) Inventor: Jack J. Sun, Palo Alto, CA (US)

(21) Appl. No.: 13/372,479

(22) Filed: Feb. 13, 2012

(51) Int. Cl. H02J 1/00

(52) U.S. Cl. 307/11

(57) ABSTRACT

An apparatus and method for non-mobile computer's solar power input interface and corresponding multiple DC outputs from solar PV panels is disclosed. In one embodiment, the invention requires no AC-DC or DC-AC conversions between solar PV panels natural DC power outputs and the power consuming computers. In another embodiment, non-mobile digital devices and equipments such as a network router or a digital TV which need low voltage DC power, can also directly use solar PV panel DC power outputs described in this invention.

### FIELD OF THE INVENTION

This invention relates to the design of computer pure green solar power supply interface and corresponding multiple DC power outputs from solar panel. The present invention relates particularly to the methods that eliminate traditional power conversion heavy loss, to improve energy efficiency and reduce the material waste.

### BACKGROUND OF THE INVENTION

At home and at organization, information appliances and computing equipment such as desktop computer and server, Network Router, digital TV, are using more and more power. As matter of fact, at a computer data center or cloud computing, power represents the dominate source of operation cost.

Almost All digital computing equipment requires standard DC power at low voltage (12v or below) for CPU, chips and circuits. Where commercial utility power come with voltage 110V, 220V or higher Alternate Current (AC) power. This is because high voltage AC can reduce long distance transmit loss. So current computer has to include a Power Supply Unit (PSU) to convert high voltage AC to low voltage DC, which usually involves about 25% power loss in terms of generating heat and hazard.

Worse is that at organization computer server room or data centers, same or more additional amount of energy must be spent on cooling systems to maintain the temperature that computers can function. Because PSU is most frequent failure parts, latest computing equipment even come with Dual Power Supply, which means use more energy loss and material waste.

Although many efforts have been giving to improve computer and data center power usage efficiency, within current computer design and power utility paradigm, average data center power usage efficiency remains about 50%.

Because a Photovoltaic (PV) panel can convert solar energy into electricity, some inventions such as U.S. Pat. No. 7,492,582,B2 provided the methods for mobile device, like laptop, as backup and short time power supply, without changing existing PSU and PV output.

There are also some commercial practice to use solar PV power, and current possible way is to first convert the DC output into AC by using an inverter, at about 20% power loss and additional cost; and then connect the inverter's AC power output to a computer PSU.

### SUMMARY OF THE INVENTION

This invention presents the method and apparatus for non-mobile computer solar or green power input interface and corresponding multiple DC outputs from a solar PV panel This invention removes all DC-AC and AC-DC conversions in between, provides highest efficiency to directly and solely use local solar power source to operate computers or digital appliances. This invention requires zero dependency on fossil fuel or nuclear based utility power; and completely eliminate the waste and possible hazard from the traditional computer Power Supply Unit (PSU)

### BRIEF DESCRIPTION OF THE DRAWINGS

FIG. 1 illustrates the function of computer power supply unit (PSU).

FIG. 2 shows one embodiment of a solar PV panel that implements the principle of the invention.

FIG. 3 shows one embodiment of a computer implements the principle of the invention.

FIG. 4 illustrates an use case that data center computers directly powered by the pure green local solar PV array, by implements the principle of the invention.

### DETAILED DESCRIPTION OF THE DRAWINGS

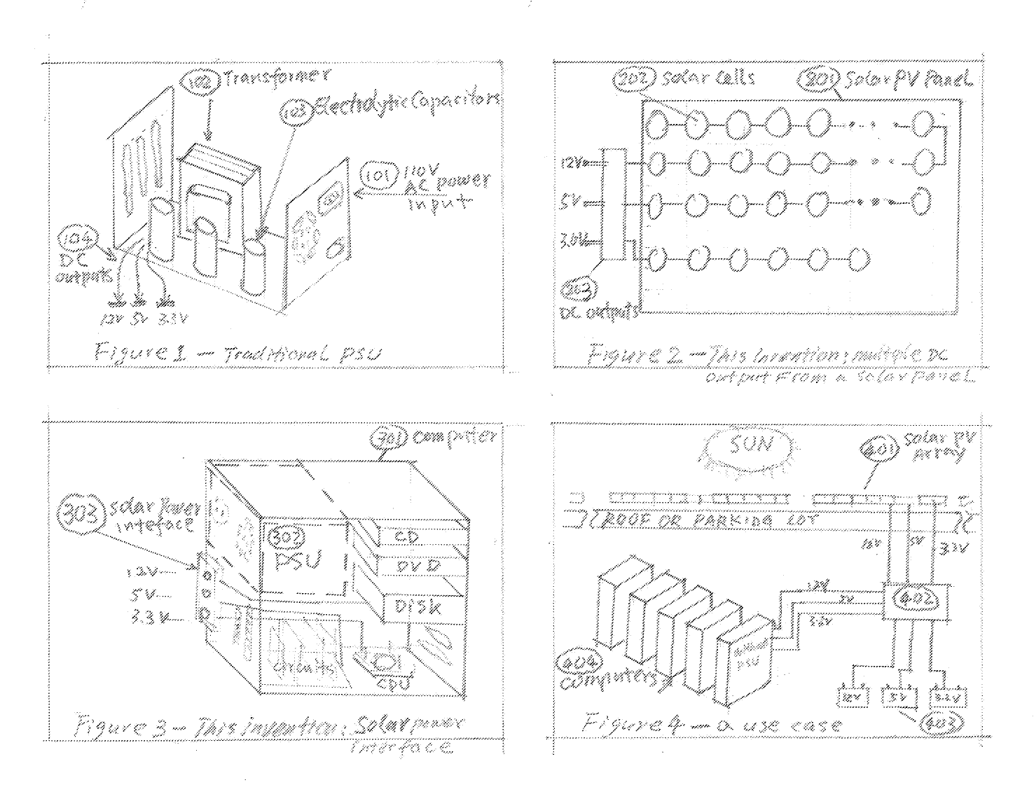

FIG. 1 shows a current computer power supply unit (PSU). Input 110V or 220V AC utility power 101 will be converted into DC power 104 with standard 12V, 5V and 33V for computer usage, with certain variance allowance. Transformer 102, Electrolytic capacitor 103 are key components of PSU, A PSU is usually heavy, hot, noisy and my contains hazardous materials such as the chemical liquid inside the capacitor.

FIG. 2 shows part one of two in this invention, the method to make a solar PV panel to deliver multiple voltages DC power. Typical Solar Panel 201 is usually three by five foot and contains about fifty solar cells 202; each cell generate about 0.6V DC power (can be controlled during manufacture process) by Photoelectric effect. With Serial connection, twenty cells yields 12V DC power output; nine cells yields 5.4V DC output; six cells yields 3.6V DC output. Solar power output male interface 203 will connect to consuming device. Parallel connection under same voltage can yield with more current to get desirable power level. More or less cells can be connected in serial to compensate short distance DC voltage drop or variance.

FIG. 3 shows part two of two in this invention, the method to change the way a computer 301 obtains DC power supply. The traditional PSU 302, in broken line, is replaced with a female solar power input interface 303, where 12V DC is usually supports disk drive; 5V DC and 3.3V DC are usually support CPU, and circuits boards.

FIG. 4 shows an use case of this invention. Where local solar panel array 401 powers the computers 404, via the coupling of the male and female solar power interfaces. The extra energy can be stored in battery pools 403; charge controller and switch 402 can be used for protection and smooth the day/night energy difference.

What is claimed is:

1. A method comprising:
multiple and different DC power outputs from a solar PV panel which include but not limited to the standard 33V, 5V, 12V DC power; and
non-mobile computers with the solar power input interface that can directly use multiple solar DC powers outputs, without AC-DC or DC-AC conversion.

2. The method of claim 1 further comprising:
A non-mobile computer or computers system that directly use Solar PV DC output (3.3V, 5V, 12V or other), without AC-DC or DC-AC conversion, or PSU.

4. The method of claim 1 further comprising:
Non-mobile digital equipments such as disk array, network gear, load balancer, or firewall that directly use Solar PV DC output (3.3V, 5V, 12V or other), without AC-DC or DC-AC conversion or power supply unit (PSU).

5. The method of claim 1 further comprising:
Information appliances such as digital TV, digital fax, digital printer that directly use Solar PV DC output (3.3V, 5V, 12V or other), without AC-DC or DC-AC conversion or power supply unit (PSU).
